(19) United States
(12) Patent Application Publication
(10) Pub. No.: US 2017/0220659 A1
(43) Pub. Date: Aug. 3, 2017

(54) SYSTEM AND METHOD OF KEY RANGE DELETIONS

(71) Applicant: Arista Networks, Inc., Santa Clara, CA (US)

(72) Inventor: Hugh W. Holbrook, Palo Alto, CA (US)

(21) Appl. No.: 15/235,016

(22) Filed: Aug. 11, 2016

Related U.S. Application Data
(60) Provisional application No. 62/288,961, filed on Jan. 29, 2016.

(51) Int. Cl. G06F 17/30; H04L 29/08

(52) U.S. Cl. CPC G06F 17/30575; H04L 67/1095; G06F 17/30303

(57) ABSTRACT

A method and apparatus of a device that updates a key range in a database for a writer of a network element that replicates changes to the database to a plurality of readers. In an exemplary embodiment, the device receives a key deletion notification for a key, where the key deletion notification is a notification to delete a key from the database and the database stores data used by the network element. The device further locates the key in an ordered data structure, the ordered data structure stores a plurality of keys in an ordered fashion. The device additionally deletes the in the ordered data structure and determines an upper and lower bound key for the deleted key. In addition, the device creates an empty key range from the upper and lower bound keys and creates an empty key range notification from the empty key range.

### RELATED APPLICATIONS

Applicant claims the benefit of priority of prior, co-pending provisional application Ser. No. 62/288,691, filed Jan. 29, 2016, the entirety of which is incorporated by reference.

### FIELD OF INVENTION

This invention relates generally to data networking, and more particularly, to supporting range deletions for keys stored in a database that is replicated across multiple readers.

### BACKGROUND OF THE INVENTION

A network element can include a database with values that change over time and are to be replicated to multiple readers that use these values. For example, a writer running on the network element writes changes to the database and a replication module sends notifications of these changes to the readers. The database can include configuration data from different sources (e.g., locally stored configuration data, via a command line interface, or other management channel such as Simple Network Management Protocol (SNMP)) and configures the data plane using the configuration data. The writer and readers can be part of the same or different network elements.

A problem with replicating the data in the database from the writer to the multiple readers is that keeping track of which data has been replicated to which reader can require one or more large data structures to keep track of the data replicated to the different readers. In addition, replicating system can have problems keeping up under a load, because as the number of changes increases, it can be difficult to keep track of which changes are to be replicated to which readers. It would useful for a replicating system to be efficient under a load, have a graceful handling of the data updates and allow for eventual consistency.

### SUMMARY OF THE DESCRIPTION

A method and apparatus of a device that updates a key range in a database for a writer of a network element that replicates changes to the database to a plurality of readers is described. In an exemplary embodiment, the device receives a key deletion notification for a key, where the key deletion notification is a notification to delete a key from the database and the database stores data used by the network element. The device further locates the key in an ordered data structure, where the ordered data structure stores a plurality of keys in an ordered fashion. The device additionally deletes the key in the ordered data structure and determines an upper and lower bound key for the deleted key. In addition, the device creates an empty key range from the upper and lower bounded keys and creates an empty key range notification from the empty key range.

In another embodiment, the device updates a key range in a reader database of a network element that receives changes to a writer database from a writer. The device receives an empty key range notification for the reader database from a writer, where the empty key range is a range between two keys where there are no keys currently defined in a writer database and the reader database stores data used by the network element and the reader database stores a plurality of keys. The device further determines an upper and lower bound key for the empty key range and deletes one or more keys between the upper and lower bound key in an ordered data structure.

Other methods and apparatuses are also described.

### BRIEF DESCRIPTION OF THE DRAWINGS

The present invention is illustrated by way of example and not limitation in the figures of the accompanying drawings in which like references indicate similar elements.

FIGS. 1A-B are block diagrams of embodiments of a system with a write node that replicates updates for a database to multiple reader nodes.

FIG. 2 is a block diagram of one embodiment of a notification queue that stores key notifications.

FIGS. 3A-B are illustrations of embodiments ordered keys.

FIG. 4 is a flow chart of one embodiment of a process to coalesce empty key ranges.

FIG. 5 is a flow diagram of one embodiment of a process to delete a key and coalesce the empty key ranges.

FIG. 6 is a flow diagram of one embodiment of a process to process a key range notification.

FIG. 7 is a flow diagram of one embodiment of a process to delete key(s) in resulting from a key range notification.

FIG. 8 is a block diagram of one embodiment of a database replication module that coalesces the empty key ranges.

FIG. 9 is a block diagram of one embodiment of a coalesce module that deletes a key and coalesces the empty key ranges.

FIG. 10 is a block diagram of one embodiment of a database reader module that processes a key range notification.

FIG. 11 is a block diagram of one embodiment of a reader coalesce module that deletes key(s) in resulting from a key range notification.

FIG. 12 illustrates one example of a typical computer system, which may be used in conjunction with the embodiments described herein.

FIG. 13 is a block diagram of one embodiment of an exemplary network element 1300 that coalesces empty key ranges.

### DETAILED DESCRIPTION

A method and apparatus of a device that updates a key range in a database for a writer of a network element that replicates changes to the database to a plurality of readers is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that updates a key range in a database for a writer of a network element that replicates changes to the database to a plurality of readers is described. In one embodiment, the device includes a writer and a database that the writer maintains by writing changes to data stored in the database. In addition, the writer replicates the changes to multiple readers that subscribe to the data in the database. The data can be stored in key, value pairs. In one embodiment, each of the readers maintains a separate local copy of the database for executing process(es) and/or thread(s) associated with the reader.

In one embodiment, the writer maintains an ordered structure of keys, where each of the keys is ordered along an ordered line. For example and in one embodiment, each of the keys is assigned a slot on the ordered line. In this embodiment, by assigning the keys along the ordered line, a set of empty key ranges can be defined between different pairs of adjacent keys. Each of the empty key ranges defines a range of slots for keys where keys can be assigned but are not currently assigned. In one embodiment, using the empty key range allows for a coalescing of deleted keys. For example and in one embodiment, multiple key deletions can be coalesced into a smaller set of empty key ranges. Thus, instead of the writer sending multiple key deletion notifications to each of the readers, the writer can coalesce these multiple key deletion into a smaller number of empty key ranges notifications. For example and in one embodiment, if the writer deletes keys K₃, K₄, K₅, K₆, and K₇ (and K₂ and K₈ are still stored in the database), instead of sending five different key deletion notifications for keys K₃, K₄, K₅, K₆, and K₇, the device coalesces the key deletions into a single empty key range (K₂, K₈). In one embodiment, the designation (K₂, K₈) means that there are not any keys stored in this ordered data structure (or the database) between keys K₂ and K₈ (exclusive).

The writer can additionally store notifications about changes to the database in a notification queue that is maintained by the writer. If a new key is added or the value of an existing key is changed, the writer adds a new key or change key notification to the notification queue, respectively. If the writer deletes a key, the writer deletes the key from the ordered data structure, coalesces the empty key ranges on either side of the deleted key in the ordered data structure into a single empty key range. The writer further creates an empty key range notification and stores this empty key range notification in the notification queue.

In one embodiment, each of the readers reads the notifications at the pace of that reader. In this embodiment, each reader has a pointer into the notification queue that represents the last notification read by the corresponding reader. In one embodiment, each reader will periodically process notifications that are ready for this reader in the notification queue. In addition, each reader may have a local copy of the database that is used by the agents associated with that reader. Furthermore, the reader can also include a key tracking data structure that is used to keep track of the keys in the local database. In this embodiment, as the reader processes the notifications, the reader adds or modifies keys and/or updates the empty key ranges in the database and/or the key tracking data structure.

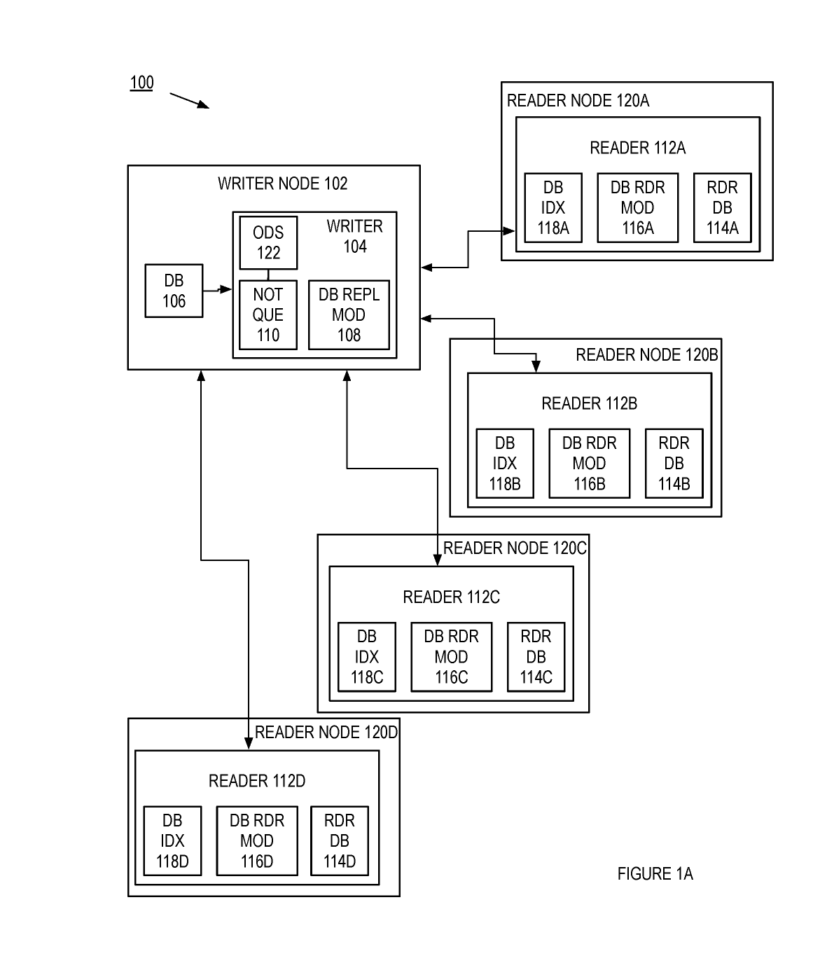

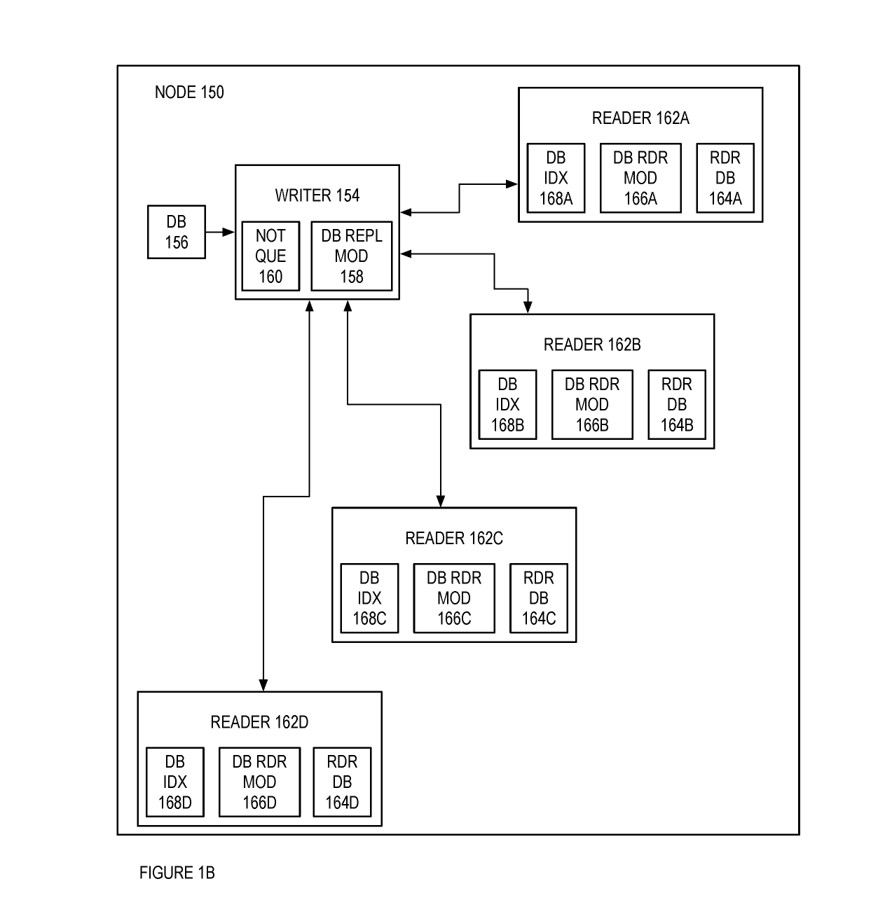

FIGS. 1A-B are block diagrams of embodiments of a system with a writer node 102 that replicates updates for a database to multiple reader nodes 120A-D. Each of the systems 100 and 150 in FIGS. 1A and 1B, respectively, illustrate a writer node writing to a database and replicating changes to the database to multiple reader nodes. That is replicated to many reader nodes using a notification queue maintained by the writer node. In FIG. 1A, system 100 includes a writer node 102 that is coupled to reader nodes 112A-D. In one embodiment, the writer node 102 includes a database 106 coupled to a writer 104. In this embodiment, the writer 104 includes a notification queue 110 and database replication module 108. The notification queue 110 is a queue that holds notifications for different keys that are stored in the database 108. In one embodiment, the notification queue 110 is coupled to an ordered data structure 122 that is used to keep track of which keys are stored in the database 106. The ordered data structure 122 is described further below. In addition, the database replication module 108 replicates the data in the database to each of the reader nodes 120A-D.

In one embodiment, the writer node 102 is a network element. In this embodiment, the network element can be can be a switch, router, hub, bridge, gateway, etc., or any type of device that can communicate data packets with a network. In one embodiment, the writer node 102 can be a virtual or physical device. In another embodiment, the writer node 102 can be a device that can communicate network data with another device (e.g., a personal computer, laptop, server, mobile device (e.g., phone, smartphone, personal gaming device, etc.), another network element, etc.). In one embodiment, the devices can be a virtual machine or can be a device that hosts one or more virtual machines. In a further embodiment, each of the reader nodes 120A-D can be a network element or a device as described above.

In one embodiment, the writer 104 writes data to the database 108. In this embodiment, the data can include configuration data, routing information, switching information, addressing information, security information, and/or other types of data to be stored in the database 106. Furthermore, the writer 104 replicates this data to the each of the reader nodes 120A-D. In addition, each of the reader nodes 120A-D uses this data to perform various functions. For example and in one embodiment, a reader node 120A-D may use the addressing information for service that relies on layer 2 or layer 3 addresses. While in one embodiment, four reader nodes 120A-D are illustrated, in alternate embodiments, there can be more or less reader nodes. For example in one embodiment, the writer 104 replicates data to dozens or hundreds of the reader nodes.

Each of these reader nodes 120A-D, in one embodiment, includes a reader 112A-D, where each of these readers 112A-D further includes the database index 118A-D, a database reader module 116A-D, and a reader database 114A-D. In this embodiment, the database index 118A-D is a data structure for the reader that keeps track of the keys stored in reader database 116A-D. In one embodiment, the database index 118A-D is an ordered data structure that stores the keys in an application specific order. The database reader module 116A-D is a module that reads the notification queue 110. For example in one embodiment, the database reader module 116A-D processes the notifications so as to update the reader database 114A-D. In addition, the reader database 114A-D includes the replicated data from the database 108. In one embodiment, the data stored in each of the reader databases 114A-D can be stored as (key, value) pairs.

In one embodiment, the replication of the data from the writer node 102 to the reader nodes 120A-D should be a replication that is efficient under load, has graceful handling, and eventual consistency. In one embodiment, as the load increases, for example, by the writer 102 increasing the number of writes and/or modifications to the data in the database increases, the replication of the data from the writer node 102 to the reader nodes 120 A-D efficiently handle the case where the writer makes changes faster than some, or all, readers can consume them. In a further embodiment, graceful handling means that if a key for value stored in the database has multiple changes, each reader node 120A-D only needs to receive the last change. For example and in one embodiment, if a key K has an initial value 10, which is changed in the sequence to 15, 10, 1, and finally 20, then a reader node 120A-D just needs to receive a notification that key K has its value changed to 20. Thus, it is not necessary that a reader knows that the intermediate values of key K. In this example, these key changes or modifications are coalesced into the last key change. By only requiring that each reader node 120A-D gets the most recent key change or modification, the requirement on the reader databases 114A-D is that each of these reader databases 114A-D will eventually be consistent with the database 108 of the writer 102. In one embodiment, this means that each of the reader databases 114A-D may temporarily have different values for intermediate values than stored in the database 108, and that the quantity and/or the ordering of the notifications sent to each of the reader databases 114A-D may be different than the quantity and/or order of the changes made to the database 108. However, eventually each of the reader databases 114 A-D will be consistent with the database 108.

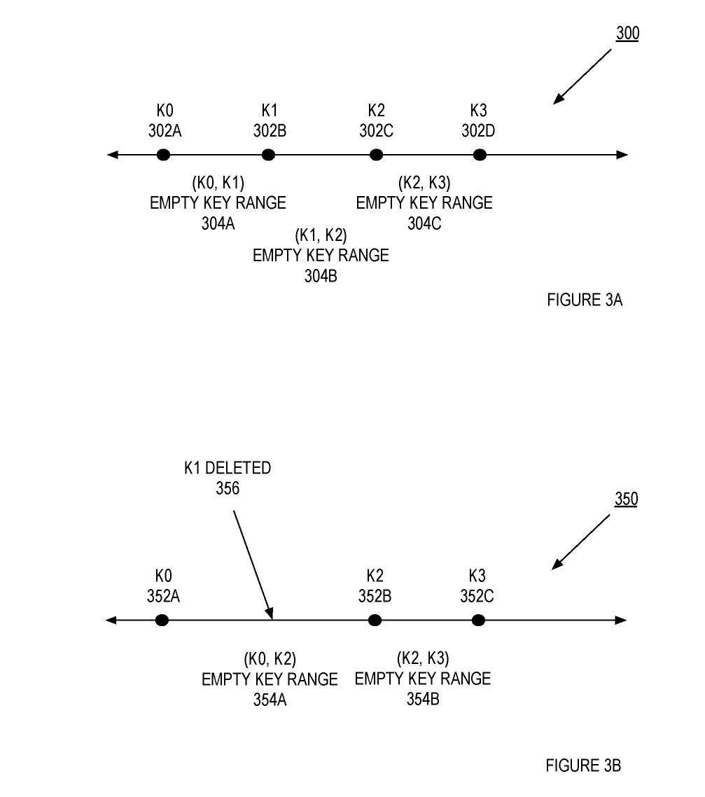

One mechanism that can be used to keep track of keys being sent to reader nodes is to use a dictionary that fronts a notification queue that keeps track of what keys have been sent to which of the reader nodes. One problem with using a dictionary is that a dictionary is required for each of the reader nodes. For example, if there are N reader nodes, then N dictionaries will be needed to keep track of which keys have been sent to the reader nodes. In one embodiment, instead of using a bookkeeping structure for each of the reader nodes, a data structure can be used to hold the ordered set of keys K₁, K₂, . . . , K_{N}. In one embodiment, the ordered set of keys can be ordered in any fashion, where each of the keys is assigned a placement or slot in that order. In one embodiment, this data structure is used to keep track if one or more of the keys are deleted. For example and in one embodiment, each of the keys is assigned an integer along a number line. In this example, K₁ can be assigned the value 1, K₂ can be assigned the value 2, and so on. With this definition, there can be defined ranges of empty spaces between these keys. In this embodiment, if K₁ is 1, K₂ is 2, K₃ is 3, etc., then (K₁, K₂) and (K₂, K₃) are the empty key ranges with no keys between the keys K₁ & K₂ and K₂ & K₃, respectively. In one embodiment, as will be further defined below, an empty key range is a range between two keys on an ordered line where there are no keys currently defined. Furthermore, if one of these keys is deleted then these empty key ranges can be coalesced into a single empty key range. For example and in one embodiment, if the key K₂ is deleted, then the empty key ranges (K₁, K₂) and (K2, K3) are coalesced into a single key range (K₁, K₃). Coalescing the empty key ranges is further described in FIGS. 3-5 below.

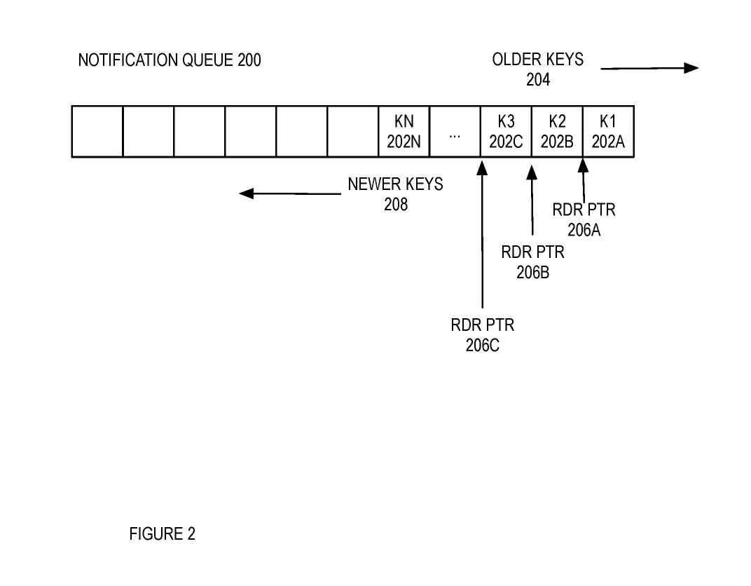

As described above, the writer 104 includes a notification queue 110 and a database replication module 108. In one embodiment, the notification queue 110 includes a set of notifications for key, value pairs. In this embodiment, each of the notifications can be one of the following types: a notification that creates a key K with value V; a notification that modifies a key K with a value V; or notification to delete key K. In this embodiment, the notification queue 110 further includes a data structure that tracks the empty key ranges. The notification queue 110 is further described in FIG. 2 below. In one embodiment, the database replication module 108 replicates the key, value notifications to the respective reader 112A-D from the notification queue 110.

As described above, and in one embodiment, the writer 104 stores the keys in an ordered data structure so that it is easier to delete keys and coalesce the keys ranges. In this embodiment, the ordered data structure includes the ordered set of keys, where each of the keys is assigned to a slot on an ordered line. In addition, in-between each pair of keys, an empty key range is defined. Ordering of the keys and the empty key ranges are further described in FIG. 2 below. In this embodiment, if the writer 104 deletes a key from database 104, the writer 104 deletes the key in the ordered data structure 122 and coalesces the empty key ranges on either side of the deleted key into a single empty key range. In addition, the writer 104 turns the delete key notification message into an empty key range notification that is added to the notification queue 110. By coalescing the empty key ranges, the complexity in maintaining the set of keys for the writer 104 and the reader 112A-D is reduced and allows for more graceful handling under load. For example and in one embodiment, K₂ is deleted, the writer 104 coalesces the empty key ranges (K₁, K₂) and (K₂, K₃) in the ordered data structure 122, and use the ordered data structure 122 to find the notifications in the notification and coalesce these notifications as well. The coalescing in the notification queue consists of deleting the empty key range notifications (K₁, K₂) and (K₂, K₃) and replacing these empty key ranger notifications with a notification for the empty key range (K₁, K₃).

As described above, each of the readers 112A-D includes a database index 118A-D, a database reader module 116A-D, and a reader database 114A-D. In one embodiment, the database index 118A-D is the local index for the reader database 114A-D. In this embodiment, the database reader module 116A-D receives the notifications from the writer node 102 and processes those notifications. In addition, the reader database 114A-D is a local version of the database 108 for that reader 112A. Thus, each of the readers 112A-D processes the received notifications so as to maintain the key values in the local database of that reader.

In one embodiment, one of more of the reader indices 118A-D includes a structure for storing the keys in a linear fashion using a hash table. In this embodiment, the reader indices 118A-D is a hash table that stores in the keys in a linear fashion, so that it is easier to delete key ranges. For example and in one embodiment, the hash table stores the keys ordered by the hash of the key. With this type of structure, deleting key range from an empty key range notification is a linear operation as a reader looks searches the hash table for the lower bound key and walks the hash table deleting intervening keys until the upper bound key is found. Thus, the processing of a key range deletion from the hash table is O(k), where k is the number of keys to be deleted. For example and in one embodiment, if there are keys K₁-K₅ stored in the hash table and the reader receives an empty key range notification for the empty key range (K₁, K₅), the reader 118A-D searches the hash table for the lower bound key (K₁) and walks the hash table deleting the intervening keys (K₂, K₃, and K₄) until the upper bound key is reached.

In FIG. 1A above, the system 100 had a writer node 104 replicating notifications to different device, namely the reader notes 112A-D. In an alternative embodiment, the writer can replicate notifications to different readers that are running on the same device. In FIG. 1B, the node 150 includes a writer 154 that replicates notifications from a database 156 to multiple readers 162A-D. In one embodiment, the writer 154 includes a notification queue 160 and a database replication module 158. In this embodiment, the notification queue 160 and database replication module 158 perform the same or similar functions as the notification queue and database replication module described in FIG. 1A above. In this embodiment, each of the readers 162A-D includes a database index 168A-D, a database reader module 166A-D, and a reader database 164A-D. In one embodiment, each of the database indices 168A-D, a database reader modules 166A-D, and a reader databases 164A-D are the database indices, database reader modules, and reader databases as described above in FIG. 1A. While in one embodiment, system 150 is illustrated with one writer 152 and four readers 162A-D, in alternate embodiments there can more or less reader nodes. For example and in one embodiment, there can be dozens or hundreds of reader for one writer. In a further embodiment, there can a writer can send empty key range notifications to a mixture of one or more readers on the same node that is hosting the writer as well as sending notifications to one or more reader nodes each hosting one or more readers.

FIG. 2 is a block diagram of one embodiment of a notification queue 200 that stores key notifications. In FIG. 2, the notification queue 200 includes slots for each of the notifications, where there is a notification for each key. In one embodiment, each of the notifications is placed into the notification queue 200 and the notification is identified by which key the notification corresponds to. In one embodiment, the different types of notifications can be: a notification to create a key K with a value V; a notification to modify a key K with the value V; or a notification to delete a key K. As notifications are generated for changes to the database, the notifications are placed in the notification queue 200 starting with notifications to the right that represent notifications for older keys 204. In addition, these notifications are progressively added to the left for newer keys 208. For example and in one embodiment, keys 220A-N are added to the notification queue 200. In a further embodiment, associated with the notification queue is a set of reader pointers 206A-C. In this embodiment, each of the reader pointers 206A-C are used to keep track of the last notification processed by a particular reader. This allows a reader to process the notifications at the speed of the reader, and not force the reader to process the notifications when the reader is dormant or otherwise unable to process the notifications. For example and in one embodiment, a reader may process the notifications quickly so as to keep an updated database as the reader is executing. In this case, a reader's pointer would be at or near the most recent notification stored in the notification queue 200. Alternatively, a reader may only need to process the notifications once in a while, such that this reader's pointer would be far from the most recent notification. This later embodiment, for example, is useful for a reader associated with the command line interface (CLI), where the reader may be stalled for a long period of time, and unable to process notifications, while waiting for input from the user. This embodiment is can be useful for any situation where the writer may make changes to the database faster than is either possible or desirable for the reader to process the notifications.

As described above, the keys are stored in an ordered data structure. In one embodiment, if there are K possible keys, the ordered data structure stores these K keys and K+1 empty key ranges. In this embodiment, by storing the keys and empty key ranges in the ordered data structure, the keys and empty key ranges are stored once and multiple copies of the copies of the keys is not needed for each of the readers. In one embodiment, the ordered data structure can be implemented in a variety of ways (e.g., a tree, AVL tree, skiplist, red-black tree, B+ tree, array, and/or another type of data structure that can store an ordered list of keys). In another embodiment, the ordered data structure for the reader node (e.g., the reader database index 118A-D as described in FIG. 1A above) can be implemented in a variety of ways (e.g., a tree, AVL tree, skiplist, red-black tree, B+ tree, array, and/or another type of data structure that can store an order list of keys). In one embodiment, where the ordering is based on the hash (e.g., the sort key is (hash(k),k)), then the hash table serves both as the sorted data structure (because it is ordered by hash(k)) and as the reader-local copy of the database.

FIGS. 3A-B are illustrations of embodiments (300 and 350) of ordered keys and a deletion of key that leads to a coalescing of two empty key ranges. In FIG. 3A, a set of keys 302A-D are ordered along an ordered line. Between each pair of keys, and empty key range can be defined. In one embodiment, an empty key range is a range between two keys on an ordered line where there are no keys currently defined. And empty key range can have zero keys where the two keys defining the empty key range occupy adjacent slots in the ordered line. For example and in one embodiment, if the ordered line was defined by a set of incrementally increasing integers (e.g., a number line) and there were keys K₂ and K₃ defined for slots 2 and 3, the empty key range defined by keys K₂ and K₃ would have no keys in that key range. As another example and embodiment, the keys 302A-D are defined on an ordered line, where each of the keys 302A-D are adjacent to one or more keys. In this example, there are three empty key ranges defined 304A-C, where each of these key ranges have no empty key slots available. As illustrated in FIG. 3A, the empty key ranges 304A-C are for the key pairs (K₀, K₁), (K₁, K₂), and (K₂, K₃). In one embodiment, the designation (Kᵢ, Kⱼ) means the empty key range between keys Kᵢ and Kⱼ, excluding the keys Kᵢ and Kⱼ.

In one embodiment, the key can be deleted through the course of the writer node performing its actions. In this embodiment, when a key is deleted, the empty key ranges will be coalesced. By coalescing these empty key ranges, there is less information to keep track of. This is because the coalesced key range has subsumed the one or more deleted keys. For example and in one embodiment, in FIG. 3B, the key K₁ is deleted (356). By deleting key K₁ (356), the ordered line has keys 352A-C, where there is an empty slot previously occupied by key K₁. Thus, instead of having three empty key ranges 304A-C as illustrated in FIG. 3A above, two of those empty key ranges are coalesced into one empty key range. For example in one embodiment, the key ranges for (K₀, K₁) 304A and (K₁, K₂) 304B can be coalesced into a single empty key range for (K₀, K₂) 354A. Thus, coalescing the empty key ranges reduces the amount of information that is needed to keep track and makes the replication of the changes of the database to the reader node more efficient.

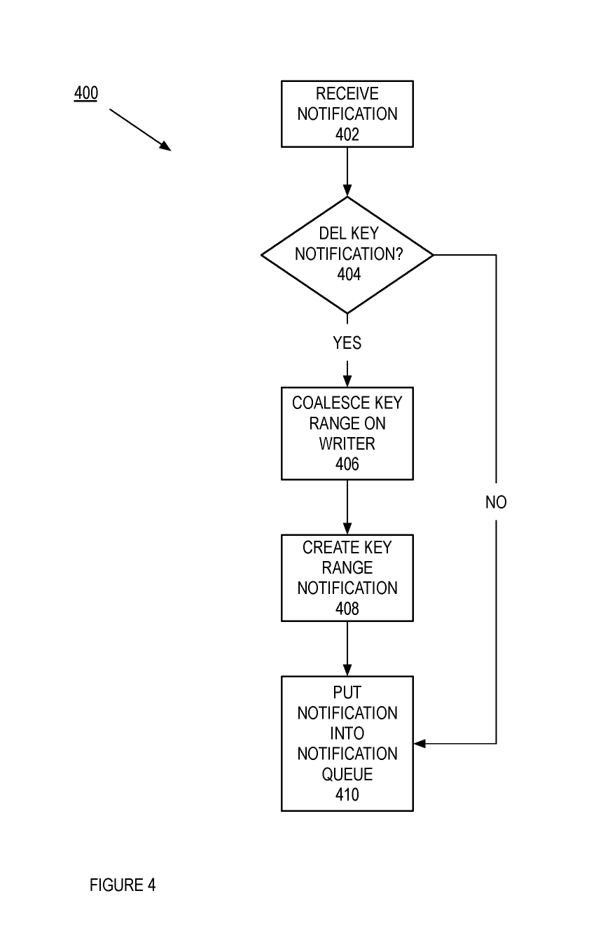

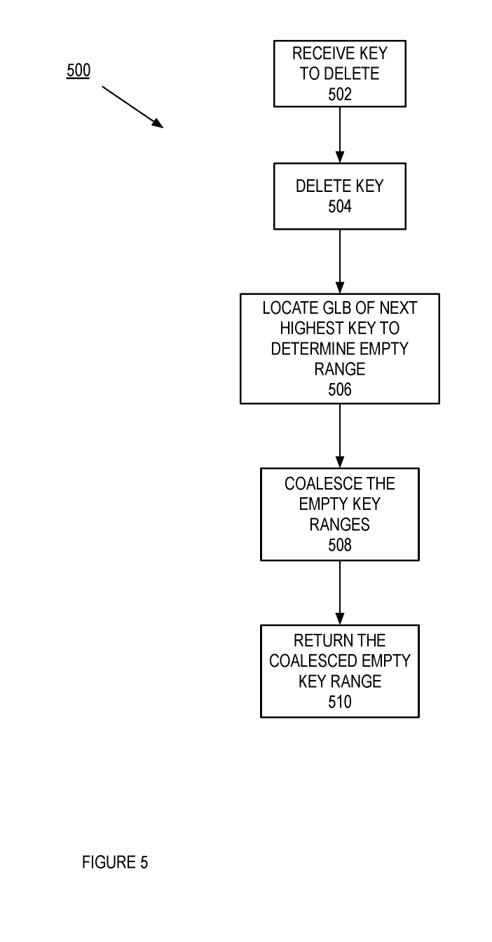

FIG. 4 is a flow chart of one embodiment of a process 400 to coalesce empty key ranges. In one embodiment, process 400 is performed by the database replication module such as the database replication module 108 as described in FIG. 1A above. In FIG. 4, process 400 begins by receiving a notification at block 402. In one embodiment, the notification is generated by a writer making a change to the database such as the writer 104 adding a key, modifying a key, or deleting a key in the database. In this embodiment, the writer replicates this change to readers that subscribe to the database. At block 404, process 400 determines if the notification is a delete key notification. If this is not a delete key notification, execution proceeds to block 410 below. If the notification is a delete key notification, process 400 coalesces the empty key ranges on the writer node at block 406. In one embodiment, process 400 coalesces the empty key ranges to the right and to the left of the deleted key into one empty key range. Coalescing the empty key ranges is further described in FIG. 5 below. Process 400 creates a key range notification at block 408. In one embodiment, process 400 creates a key range notification that identifies the new empty key range as determined in block 406 above. For example and in one embodiment, if there are keys K₁, K₂, and K₃ and key K₂ is deleted, process 400 would generate an empty key range of (K₁, K₃). In addition, process 400 would consume the delete K₂ key notification and generate an empty key range (K₁, K₃) notification. At block 410, process 400 puts the new empty key range notification into the notification queue. In addition, process 400 removes the outdated empty key range notifications. In the example above, before process 400 deletes the key K₂, there could exist empty key range notifications for empty key ranges (K₁, K₂) and (K₂, K₃). In this example, process 400 coalesces the empty key ranges (K₁, K₂) and (K₂, K₃) into the empty key range (K₁, K₃) in the ordered data structure by deleting the empty key range notifications (K₁, K₂) and (K₂, K₃) from the notification queue, and adding the empty key range notification (K₁, K₃) to the notification queue. For example and in one embodiment, process 400 would put the notification into the notification queue 110, which is later processed by the readers.

FIG. 5 is a flow diagram of one embodiment of a process 500 to delete a key and coalesce the empty key ranges. In one embodiment, process 500 is performed by process 400 to coalesce empty key ranges as a result of a key deletion. In FIG. 5, process 500 begins by receiving a key to delete at block 502. In one embodiment, process 500 receives a key to delete by receiving a delete key notification. At block 504, process 500 deletes the key. In one embodiment, if the keys are ordered using a linked list, process 500 can unlink the link storing the key and link up the preceding key with the next key. In one embodiment, the keys are stored in an ordered data structure that includes two functions to return information about these keys. In this embodiment, the key functions are lookup (key), which returns the key entry in the ordered data structure and greatest lower bound (GLB) (key), which returns the entry to the left of the key in the ordered data structure and represents another key with the greatest value that is less than the value of the key. In one embodiment, these two functions are used to coalesce the empty key ranges created by a key deletion.

With one of the empty key ranges defined, process 500 will still need to determine the second empty key range. At block 506, process 500 determines the greatest lower bound of the next highest key so as to determine the empty key range. In one embodiment, process 500 uses the greatest lower bound function with the input of the next highest key to determine the greatest lower bound to determine the second empty key range. With the two empty key ranges, process 500 coalesces the two empty key ranges at block 508. For example in one embodiment, assume there are keys K₁, K₃ and K₅ defined on an ordered line with the slots for keys K₂ and K₄ being empty. In this embodiment, there are empty key ranges (K₁, K₃) and (K₃, K₅). Process 500 receives a notification to delete key K₃. In this example, process 500 deletes key K₃ and updates the data structures accordingly. Process 500 further finds the greatest lower bound for the next highest key. In this case the next highest key of K₃ is K₅ and with key K₃ deleted, the greatest lower bound of key K₅ is K₁. Thus, process 500 has deleted the key K₃ and coalesced the empty key ranges (K₁, K₃) and (K₃, K₅) into the new empty key range (K₁, K₅). Process 500 returns the coalesced empty key range at block 510.

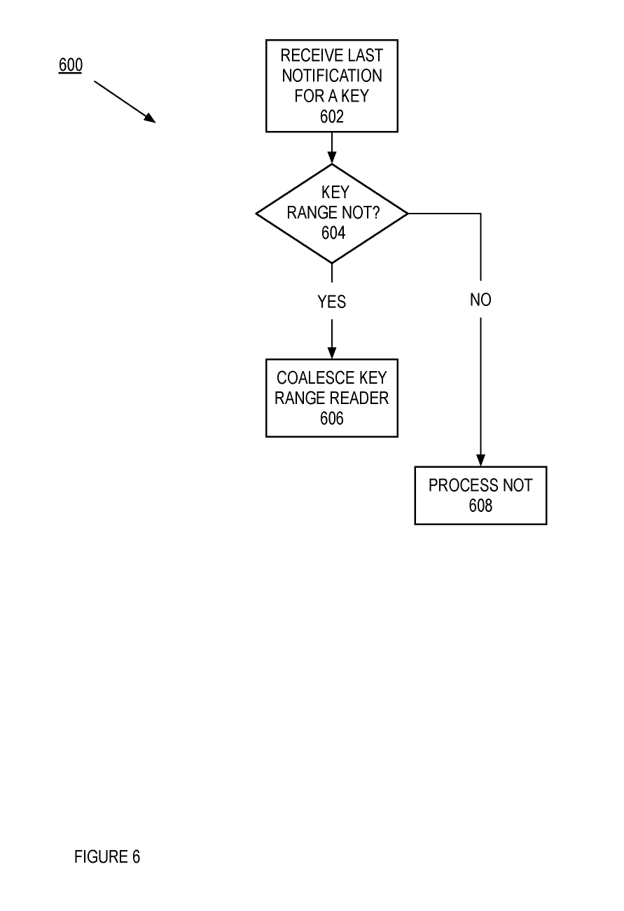

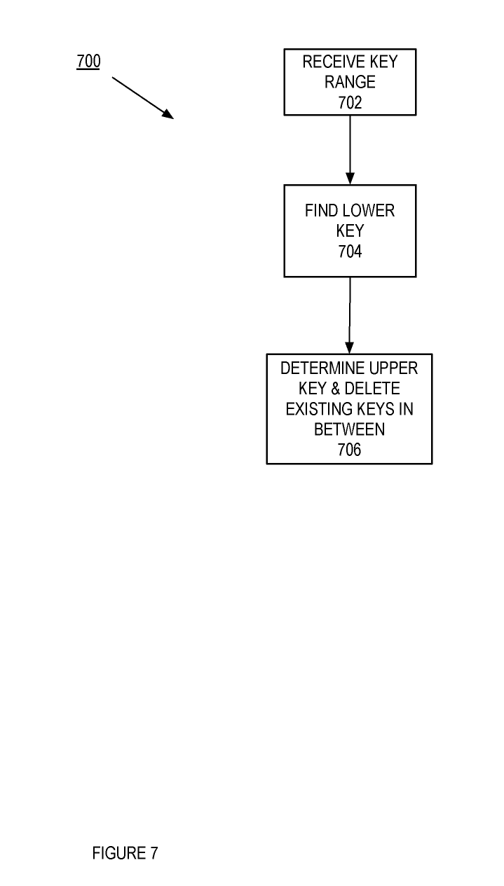

FIG. 6 is a flow diagram of one embodiment of a process 600 to process a key range notification. In one embodiment, process 600 is performed by a database reader module such as the database reader modules 116A-D as described in FIG. 1A above. In FIG. 6, process 600 begins by receiving the last notification for a key at block 602. In one embodiment, process 600 just processes the last notification for a key as previous notifications for a key are not needed for the reader to store the latest value for that key. For example and in one embodiment, if a key K₁ was created with the value 15, where the value was later modified to 10, deleted, created with the value 200, and lastly modified to the value of 1, process 600 would just process a notification for the key K₁ where its value has been modified to the value of 1. At block 604, process 600 determines if the notification is a key range notification. If the notification is a key range notification, process 600 coalesces the key ranges for the reader at block 606. Coalescing the key ranges for the reader is further described in FIG. 7 below. If the notification is not a key range notification, process 600 processes the notification at block 608.

FIG. 7 is a flow diagram of one embodiment of a process 700 to delete key(s) in resulting from a key range notification. In one embodiment, process 700 is performed by process 600 to process the key range notification. In FIG. 7, process 700 begins by receiving a key range notification at block 702. In one embodiment, a key range notification includes upper and lower keys that define an empty key range space between those two keys. At block 704, process 700 finds the lower key in the key range notification. Furthermore, process 700 determines the upper key in the key range notification and deletes the existing keys in between the upper and lower keys at block 706. In one embodiment, by deleting these intervening keys, the empty key ranges in the writer database are reflected in the reader database.

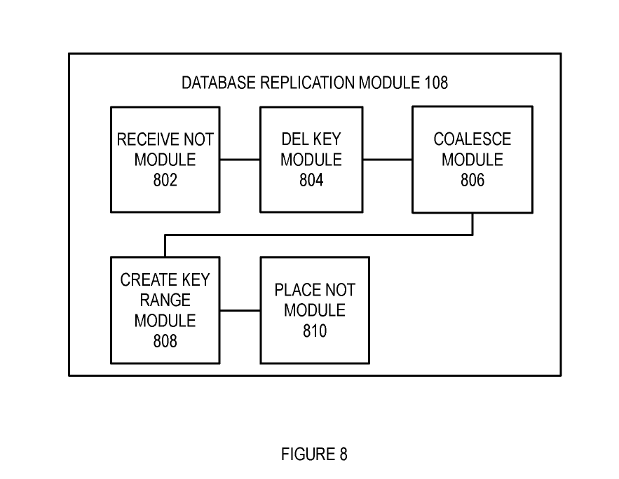

FIG. 8 is a block diagram of one embodiment of a database replication module 108 that coalesces the empty key ranges. In one embodiment, the database replication module 108 includes a receive notification module 802, delete key module 804, coalesce module 806, create key range module 808, and place notification module 810. In one embodiment, the receive notification module 802 receives the notification message as described in FIG. 4, block 402 above. The delete key module 804 determines if the notification is a delete key notification message as described in FIG. 4, block 404 above. The coalesce module 806 coalesces the key range as described in FIG. 4, block 406 above. The create key range module 808 creates the empty key range notification as described in FIG. 4, block 408 above. The place notification module 810 places the empty key range notification message as described in FIG. 4, block 410 above.

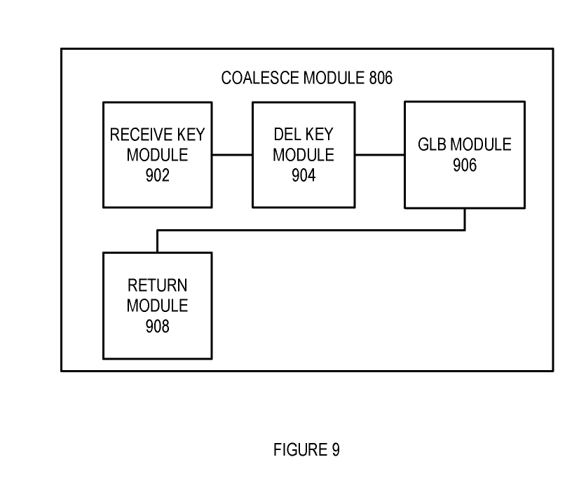

FIG. 9 is a block diagram of one embodiment of a coalesce module 806 that deletes a key and coalesces the empty key ranges. In one embodiment, the coalesce module 806 includes a receive key module 902, delete key module 904, GLB module 906, and return module 908. In one embodiment, the receive key module 902 receives the key to delete as described in FIG. 5, block 502 above. The delete key module 904 deletes the key as described in FIG. 5, block 504 above. The GLB module 906 determines the greatest lower bound (GLB) of the next highest key to the deleted key to determine the empty key range as described in FIG. 5, block 506 above. The return module 908 returns the coalesced empty key range as described in FIG. 5, block 508 above.

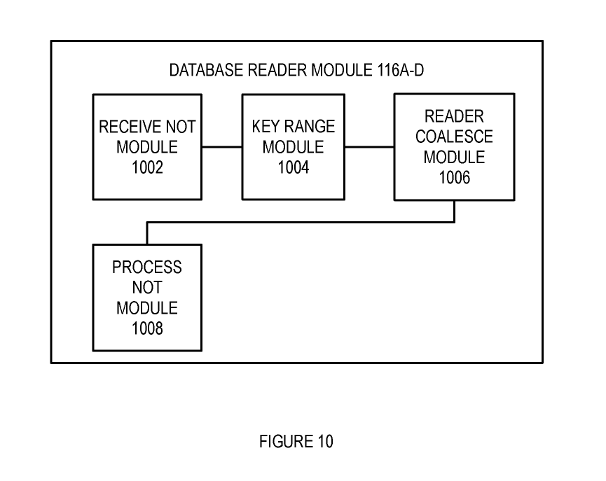

FIG. 10 is a block diagram of one embodiment of a database reader module that processes a key range notification. In one embodiment, the database reader module 116A-D includes a receive notification module 1002, key range module 1004, reader coalesce module 1006, and process notification module 1008. In one embodiment, the receive notification module 1002 receives a notification as described in FIG. 6, block 602 above. The key range module 1004 determines if the notification is a key range notification as described in FIG. 6, block 604 above. The reader coalesce module 1006 coalesces the key range for the reader as described in FIG. 6, block 606 above. The process notification module 1008 processes the notification as described in FIG. 6, block 608 above.

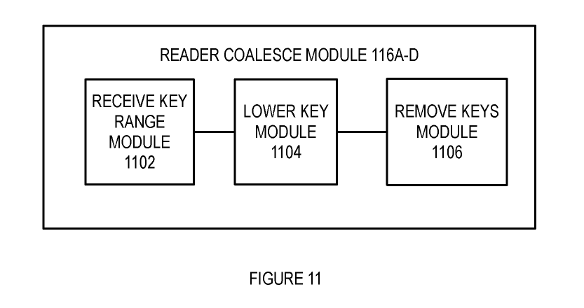

FIG. 11 is a block diagram of one embodiment of a reader coalesce module 1006 that deletes key(s) resulting from a key range notification. In one embodiment, the reader coalesce module 1006 includes a receive key range module 1102, lower key module 1104, and remove keys module 1106. In one embodiment, the receive key range module 1102, lower key module 1104, and remove keys module 1106. In one embodiment, the receive key range module 1102 receives the key range as described in FIG. 7, block 702 above. The lower key module 1104 determines lower key in the key range as described in FIG. 7, block 704 above. The remove keys module 1106 removes the key(s) in-between the lower and upper keys as described in FIG. 7, block 706 above.

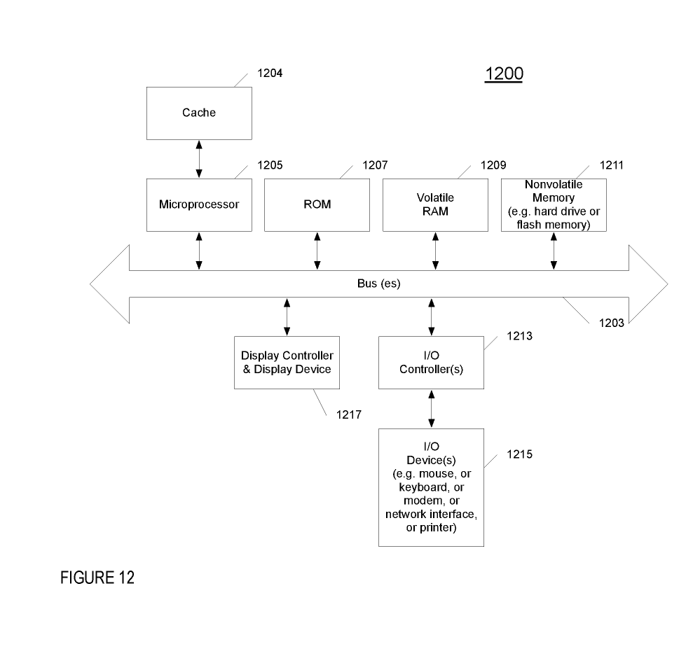

FIG. 12 shows one example of a data processing system 1200, which may be used with one embodiment of the present invention. For example, the system 1200 may be implemented including a writer node 102 as shown in FIG. 1A above. Note that while FIG. 12 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 12, the computer system 1200, which is a form of a data processing system, includes a bus 1203 which is coupled to a microprocessor(s) 1205 and a ROM (Read Only Memory) 1207 and volatile RAM 1209 and a non-volatile memory 1211. The microprocessor 1205 may retrieve the instructions from the memories 1207, 1209, 1211 and execute the instructions to perform operations described above. The bus 1203 interconnects these various components together and also interconnects these components 1205, 1207, 1209, and 1211 to a display controller and display device 1217 and to peripheral devices such as input/output (110) devices which may be mice, keyboards, modems, network interfaces, printers and other devices which are well known in the art. In one embodiment, the system 1200 includes a plurality of network interfaces of the same or different type (e.g., Ethernet copper interface, Ethernet fiber interfaces, wireless, and/or other types of network interfaces). In this embodiment, the system 1200 can include a forwarding engine to forward network date received on one interface out another interface.

Typically, the input/output devices 1215 are coupled to the system through input/output controllers 1213. The volatile RAM (Random Access Memory) 1209 is typically implemented as dynamic RAM (DRAM), which requires power continually in order to refresh or maintain the data in the memory.

The mass storage 1211 is typically a magnetic hard drive or a magnetic optical drive or an optical drive or a DVD ROM/RAM or a flash memory or other types of memory systems, which maintains data (e.g. large amounts of data) even after power is removed from the system. Typically, the mass storage 1211 will also be a random access memory although this is not required. While FIG. 12 shows that the mass storage 1211 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1203 may include one or more buses connected to each other through various bridges, controllers and/or adapters as is well known in the art.

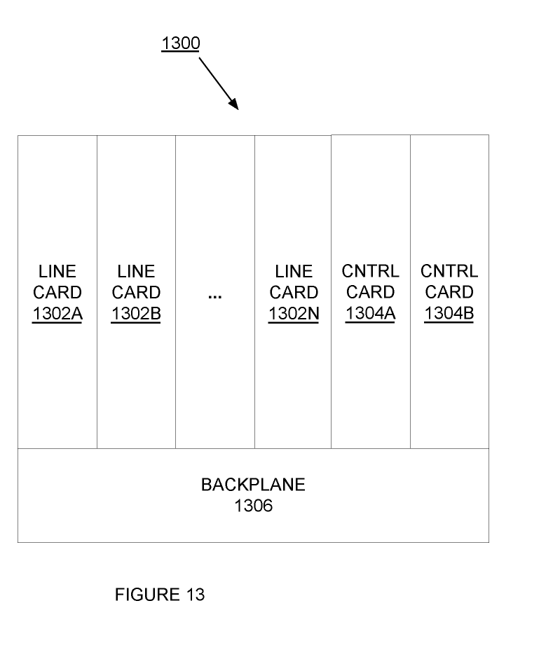

FIG. 13 is a block diagram of one embodiment of an exemplary network element 1300 that coalesces empty key ranges. In FIG. 13, the interconnect 1306 couples to the line cards 1302A-N and controller cards 1304A-B. While in one embodiment, the controller cards 1304A-B control the processing of the traffic by the line cards 1302A-N, in alternate embodiments, the controller cards 1304A-B, perform the same and/or different functions (e.g., coalescing empty key ranges). In one embodiment, the controller cards 1304A-B coalesces key ranges as described in FIGS. 4 and 5. In this embodiment, one or both of the controller cards 1304A-B include a writer node to coalesce key ranges, such as the writer 102 as described in FIG. 1A above. In another embodiment, the line cards 1302A-N receive notifications to coalesce key ranges as described in FIGS. 6 and 7. In this embodiment, one or more of the line cards 1702A-N include the reader node to process notifications, such as the reader node 120A-D as described in FIG. 1A above. It should be understood that the architecture of the network element 1300 illustrated in FIG. 13 is exemplary, and different combinations of cards may be used in other embodiments of the invention.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “process virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “locating,” “determining,” “deleting,” “failing,” “creating,” “increasing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to update a key range in a database for a writer of a network element that replicates changes to the database to a plurality of readers, the method comprises:
receiving a key deletion notification for a key in the database, wherein the key deletion notification is a notification to delete a key from the database and the database stores data used by the network element;
locating the key in an ordered data structure, the ordered data structure stores a plurality of keys in an ordered fashion;
deleting the key in the ordered data structure;
determining an upper and lower bound key for the deleted key;
creating an empty key range from the upper and lower bounded keys; and
creating an empty key range notification from the empty key range.

2. The non-transitory machine-readable medium of claim 1, wherein the key deletion notification is generated in response to the key being deleted in the database.

3. The non-transitory machine-readable medium of claim 1, further comprising:
placing the empty key range notification in the notification queue.

4. The non-transitory machine-readable medium of claim 3, wherein the placing of the empty key range in the notification queue further comprises:
removing another empty key range notification stored in the notification queue that overlaps with the placed empty key range notification.

5. The non-transitory machine-readable medium of claim 1, wherein the database stores the data using a plurality of key, value pairs.

6. The non-transitory machine-readable medium of claim 1, wherein the empty key range is a range between two keys on an ordered structure where there are no keys currently defined.

7. The non-transitory machine-readable medium of claim 1, wherein the empty key range is an exclusive key range between the upper and lower bound keys.

8. The non-transitory machine-readable medium of claim 1, wherein the plurality of keys stored in the database is ordered at least by a hash of those keys.

9. A method to update a key range in a database for a writer of a network element that replicates changes to the database to a plurality of readers, the method comprises:
receiving a key deletion notification for a key in the database, wherein the key deletion notification is a notification to delete a key from the database and the database stores data used by the network element;
locating the key in an ordered data structure, the ordered data structure stores a plurality of keys in an ordered fashion;
deleting the key in the ordered data structure;
determining an upper and lower bound key for the deleted key;
creating an empty key range from the upper and lower bounded keys; and
creating an empty key range notification from the empty key range.

10. The method of claim 9, wherein the key deletion notification is generated in response to the key being deleted in the database.

11. The method of claim 9, further comprising:
placing the empty key range notification in the notification queue.

12. The method of claim 11, wherein the placing of the empty key range in the notification queue further comprises:
removing another empty key range notification stored in the notification queue that overlaps with the placed empty key range notification.

13. The method of claim 9, wherein the database stores the data using a plurality of key, value pairs.

14. The method of claim 9, wherein the empty key range is a range between two keys on an ordered structure where there are no keys currently defined.

15. The method of claim 9, wherein the empty key range is an exclusive key range between the upper and lower bound keys.

16. The method of claim 9, wherein the plurality of keys stored in the database is ordered at least by a hash of those keys.

17. A non-transitory machine-readable medium having executable instructions to cause one or more processing units to perform a method to update a key range in a reader database of a network element that receives changes to a writer database from a writer, the method comprises:
receiving an empty key range notification for the reader database from a writer, wherein the empty key range is a range between two keys where there are no keys currently defined in a writer database and the reader database stores data used by the network element and the reader database stores a plurality of keys;
determining an upper and lower bound key for the empty key range; and
deleting one or more keys between the upper and lower bound key in an ordered data structure.

18. The non-transitory machine-readable medium of claim 17, wherein the empty key range is an exclusive key range between the upper and lower bound keys.

19. The non-transitory machine-readable medium of claim 17, wherein the plurality of keys stored in the reader database is ordered at least by a hash of those keys.

20. The non-transitory machine-readable medium of claim 17, wherein the ordered data structure is part of the reader database and stores a plurality of values corresponding to the plurality of keys.
